(19) United States
(12) Patent Application Publication
(10) Pub. No.: US 2026/0013524 A1
(43) Pub. Date: Jan. 15, 2026

(54) JASMINE ESSENTIAL OIL-CHITOOLIGOSACCHARIDE-CELLULOSE COMPOSITE, AND PREPARATION METHOD THEREFOR AND USE THEREOF

(71) Applicant: Anhui Agricultural University, Hefei City (CN)

(72) Inventors: Xiaoting ZHAI, Hefei City (CN); Xin YAO, Hefei City (CN); Xiaoyu ZHANG, Hefei City (CN); Jieyao YU, Hefei City (CN); Hui WANG, Hefei City (CN); Jing WANG, Hefei City (CN); Xiaochun WAN, Hefei City (CN)

(21) Appl. No.: 18/949,232

(22) Filed: Nov. 15, 2024

(30) Foreign Application Priority Data
Jul. 9, 2024 (CN) 202410917897.8

(51) Int. Cl. A23F 3/40; A23L 27/00; A23L 27/12

(52) U.S. Cl. CPC A23F 3/405; A23L 27/12; A23L 27/72

(57) ABSTRACT

The present disclosure belongs to the technical field of aroma enhancement of instant tea, and in particular relates to a jasmine essential oil-chitooligosaccharide-cellulose composite, and a preparation method therefor and use thereof. The jasmine essential oil-chitooligosaccharide-cellulose composite of the present disclosure is prepared by a method including mixing chitooligosaccharides and an acidic solution, mixing cellulose and water, and mixing the two milky solutions obtained to obtain a chitooligosaccharide-cellulose emulsion; and then mixing the emulsion with jasmine essential oil to obtain the jasmine essential oil-chitooligosaccharide-cellulose composite. In the present disclosure, encapsulating a natural jasmine essential oil in a chitooligosaccharide-cellulose composite may not only effectively prevent jasmine essential oil from oxidation when exposed to light and oxygen, but also transform a liquid fragrance into solid form.

### CROSS-REFERENCE TO RELATED APPLICATION

This patent application claims the benefit and priority of Chinese Patent Application No. 2024109178978 filed with the China National Intellectual Property Administration on Jul. 9, 2024, the disclosure of which is incorporated by reference herein in its entirety as part of the present application.

### TECHNICAL FIELD

The present disclosure belongs to the technical field of aroma enhancement of flavored instant tea, and in particular relates to a jasmine essential oil-chitooligosaccharide-cellulose composite, and a preparation method therefor and use thereof.

### BACKGROUND

Instant tea is a new granular or powdered beverage that is water-soluble and free of tea residue, made from finished tea, semi-finished tea, tea byproducts, or fresh leaves. It is processed via processes such as extraction, filtration, redissolving, concentration, and drying. Compared to traditional brewed tea, instant tea has several advantages such as a wide range of raw material sources, convenience and quick to drink, economical and environmentally friendly benefits, high content of active ingredients, and low pesticide residues. Instant tea products can be formulated with water, juice, sugar, etc., to cater to the diverse preferences of consumers and better suit the fast-paced life of modern individuals who seek nutritional well-being, and therefore are highly popular among consumers and have promising market prospects.

The processing of instant tea involves a series of processes, resulting in the volatilization and loss of most of the aroma. However, aroma is one of the key factors in evaluating the quality of a tea beverage and is an important indicator for distinguishing the quality of tea leaves. To solve the problem of aroma defficiency in instant tea, one approach is to enhance the aroma of the instant tea by exogenously adding natural floral-scent essential oils to create flavored instant tea. Jasmine essential oil extracted from Jasmine is an important raw material in the fragrance industry and is widely used in food, and daily chemical production. However, jasmine essential oil is prone to oxidize when exposed to light and oxygen during storage, and its aroma is quickly released upon use, making it unsuitable for enhancing the aroma of instant tea.

### SUMMARY

In view of this, an objective of the present disclosure is to provide a jasmine essential oil-chitooligosaccharide-cellulose composite, and a preparation method therefor and use thereof. In the present disclosure, jasmine essential oil is encapsulated with a chitooligosaccharide-cellulose composite, allowing for good aroma stability.

In order to achieve the objective described above, the present disclosure provides the following technical solutions.

The present disclosure provides a jasmine essential oil-chitooligosaccharide-cellulose composite, comprising a shell material formed from a chitooligosaccharide-cellulose composite, and jasmine essential oil encapsulated in the shell material.

In some embodiments, a ratio of the shell material to the jasmine essential oil is 0.33 g:150-200 μL.

The present disclosure further provides a method for preparing the jasmine essential oil-chitooligosaccharide-cellulose composite described in the technical solution above, the preparation method including the following steps:

mixing chitooligosaccharides and an acidic solution to obtain a first milky solution, and mixing cellulose and water to obtain a second milky solution;

mixing the first milky solution and the second milky solution for emulsification to obtain a chitooligosaccharide-cellulose emulsion; and

conducting encapsulation of jasmine essential oil with the chitooligosaccharide-cellulose emulsion to obtain the jasmine essential oil-chitooligosaccharide-cellulose composite.

In some embodiments, the acidic solution is an acetic acid solution, acetic acid in the acetic acid solution accounts for 1% by volume fraction, and the chitooligosaccharides has a concentration of 0.5 g/mL in the first milky solution.

In some embodiments, cellulose has a concentration of 0.5 g/mL in the second milky solution.

In some embodiments, a mass ratio of chitooligosaccharide to cellulose in the chitooligosaccharide-cellulose emulsion is 1-4:1-2.

In some embodiments, the encapsulation includes: mixing the chitooligosaccharide-cellulose emulsion and the jasmine essential oil and stirring same at a rotational speed of 500 r/min for 6 h.

The present disclosure further provides use of the jasmine essential oil-chitooligosaccharide-cellulose composite described in the technical solution above or the jasmine essential oil-chitooligosaccharide-cellulose composite obtained by the preparation method above in flavored instant tea.

In some embodiments, the flavored instant tea includes one or more of instant black tea, instant green tea, instant white tea, instant dark tea, and instant oolong tea.

In some embodiments, a mass ratio of the instant black tea to the jasmine essential oil-chitooligosaccharide-cellulose composite is 1 g:0.002-0.004 g; a mass ratio of the instant green tea to the jasmine essential oil-chitooligosaccharide-cellulose composite is 1 g:0.002-0.004 g; a mass ratio of the instant white tea to the jasmine essential oil-chitooligosaccharide-cellulose composite is 1 g:0.002-0.006 g; a mass ratio of the instant dark tea to the jasmine essential oil-chitooligosaccharide-cellulose composite is 1 g:0.002-0.006 g; and a mass ratio of the instant oolong tea to the jasmine essential oil-chitooligosaccharide-cellulose composite is 1 g:0.006-0.01 g.

Compared with conventional technology, embodiments of the present disclosure have the following beneficial effects.

The present disclosure provides a jasmine essential oil-chitooligosaccharide-cellulose composite, comprising a shell material formed from a chitooligosaccharide-cellulose composite, and jasmine essential oil encapsulated in the shell material.

In the present disclosure, encapsulation of natural jasmine essential oil in a chitooligosaccharide-cellulose composite may not only effectively prevent jasmine essential oil from oxidation when exposed to light and oxygen during storage, but also transform liquid fragrance to solid form. As to the jasmine essential oil-chitooligosaccharide-cellulose composite of the present disclosure, it demonstrates good encapsulation efficiency for jasmine essential oil. The jasmine essential oil-chitooligosaccharide-cellulose composite has good aroma stability, making it suitable for incorporation into instant tea powder. This composite plays a positive role in increasing the aroma component of flavored instant tea.

The present disclosure further provides a method for preparing the jasmine essential oil-chitooligosaccharide-cellulose composite. The specific mass ratio of chitooligosaccharide to cellulose and specific mass ratio of the shell material to the jasmine essential oil in the present disclosure result in a shell material that is smooth without depressions, and has uniform particle sizes and high encapsulation efficiency for jasmine essential oil.

The data from the examples show that the aroma quality of the tea infusion from the instant black tea and instant green tea infused with the jasmine essential oil-chitooligosaccharide-cellulose composite is significantly improved.

In the present disclosure, the jasmine essential oil-chitooligosaccharide-cellulose composite is added to various instant tea powders (including instant black tea, instant green tea, instant white tea, instant dark tea, and instant oolong tea). The effect of the addition of the jasmine essential oil-chitooligosaccharide-cellulose composite on the aroma of instant tea powders is analyzed via sensory evaluation combined with aroma analysis technology, providing a theoretical basis for improving the aroma quality of flavored instant tea powder.

### BRIEF DESCRIPTION OF THE DRAWINGS

In order to illustrate the technical solutions in the examples of the present disclosure or the prior art more clearly, a brief introduction to the drawings necessary for the examples will be provided below. Apparently, the drawings in the following description are merely some of the embodiments of the present disclosure, and those of ordinary skill in the art can also obtain other drawings according to these drawings without involving any inventive effort.

FIG. 1 shows the technology roadmap of the present disclosure;

FIGS. 2A-2E show the scanning electron microscopy results of chitooligosaccharide-cellulose composite;

FIGS. 3A-3B show the scanning electron microscopy results of chitooligosaccharide-cellulose composite (FIG. 3A) and jasmine essential oil-chitooligosaccharide-cellulose composite (FIG. 3B);

FIG. 4 shows the Fourier infrared spectra of chitooligosaccharide, cellulose, and chitooligosaccharide-cellulose composite, where (a) represents chitooligosaccharide-cellulose composite; (b) represents chitooligosaccharide; and (c) represents cellulose;

FIG. 5 shows the change in the content of aroma compounds with strong odor intensity in jasmine essential oil;

FIGS. 6A-6E show the aroma profile graphs of various instant tea powders, where in FIG. 6A, IBT is instant black tea, and IBT+JEO-C is instant black tea infused with the jasmine essential oil-chitooligosaccharide-cellulose composite; in FIG. 6B: IGT is instant green tea, and IGT+JEO-C is instant green tea infused with the jasmine essential oil-chitooligosaccharide-cellulose composite; in FIG. 6C, IWT is instant white tea, and IWT+JEO-C is instant white tea infused with the jasmine essential oil-chitooligosaccharide-cellulose composite; in FIG. 6D, IDT is instant dark tea, and IDT+JEO-C is instant dark tea infused with the jasmine essential oil-chitooligosaccharide-cellulose composite; in FIG. 6E, IOT is instant oolong tea, and IOT+JEO-C is instant oolong tea infused with the jasmine essential oil-chitooligosaccharide-cellulose composite; and * indicates significant difference (p<0.05), ** indicates extremely significant difference (p<0.01), and items without * indicate that there is no significant difference (p>0.05);

FIG. 7 shows the content of floral aromatic compounds in instant black tea; and

FIG. 8 shows the content of floral aromatic compounds in instant green tea.

### DETAILED DESCRIPTION OF THE EMBODIMENTS

The present disclosure provides a jasmine essential oil-chitooligosaccharide-cellulose composite, comprising a shell material formed from a chitooligosaccharide-cellulose composite, and jasmine essential oil encapsulated in the shell material.

In the present disclosure, the ratio of the shell material to the jasmine essential oil is preferably 0.5 g:150-200 μL. The encapsulation efficiency of the chitooligosaccharide-cellulose composite for jasmine essential oil is preferably 30-60%, more preferably 50-51%.

In the present disclosure, the mass ratio of chitooligosaccharide to cellulose in the shell material is preferably 1-4:1-2, more preferably 1:2, 1:1, 2:1, 3:1, or 4:1.

The present disclosure further provides a method for preparing the jasmine essential oil-chitooligosaccharide-cellulose composite described in the technical solution above, the method including the following steps:

mixing chitooligosaccharides and an acidic solution to obtain a first milky solution, and mixing cellulose and water to obtain a second milky solution;

mixing the first milky solution and the second milky solution for emulsification to obtain a chitooligosaccharide-cellulose emulsion; and conducting encapsulation of jasmine essential oil with the chitooligosaccharide-cellulose emulsion to obtain the jasmine essential oil-chitooligosaccharide-cellulose composite.

In the present disclosure, unless otherwise specified, the materials and equipment used are commercially available in the art.

In the present disclosure, a chitooligosaccharide and an acidic solution are mixed to obtain a first milky solution, and cellulose and water are mixed to obtain a second milky solution.

In the present disclosure, the chitooligosaccharide has a weight average molecular weight of preferably less than 5000 Da. The acidic solution is preferably an acetic acid solution, and the volume fraction of acetic acid in the acetic acid solution is preferably 1%. The mass ratio of the chitooligosaccharide to the acidic solution is preferably 1 g:2 mL. In the present disclosure, chitooligosaccharide is used as a raw material. Chitooligosaccharide has characteristics such as small molecular weight, low degree of polymerization, and good water solubility, and is more easily absorbed by the intestinal epithelium through intestinal metabolism.

In the present disclosure, the concentration of the chitooligosaccharides in the first milky solution is preferably 0.5 g/mL.

In the present disclosure, the cellulose is preferably cellulose nanofiber, and the mass ratio of cellulose to water is preferably 1 g:2 mL. The concentration of the cellulose in the second milky solution is 0.5 g/mL.

In the present disclosure, after the first milky solution and the second milky solution is obtained, the first milky solution and the second milky solution are mixed for emulsification to obtain a chitooligosaccharide-cellulose emulsion.

In the present disclosure, the mass ratio of chitooligosaccharide to cellulose in the chitooligosaccharide-cellulose emulsion is preferably 1-4:1-2, more preferably 1:2, 1:1, 2:1, 3:1, or 4:1.

In the present disclosure, mixing the first milky solution and the second milky solution preferably includes: stirring the resulting mixed solution at a rotational speed of preferably 500 r/min for preferably 6 h, where the stirring is preferably magnetic stirring.

In the present disclosure, after obtaining the chitooligosaccharide-cellulose emulsion, the jasmine essential oil is encapsulated with the chitooligosaccharide-cellulose emulsion to obtain a jasmine essential oil-chitooligosaccharide-cellulose composite.

In the present disclosure, the mass ratio of the chitooligosaccharide-cellulose emulsion to the jasmine essential oil is preferably 1 g: 150-200 μL. The ratio of the total amount of the chitooligosaccharide and cellulose to the amount of the jasmine essential oil is preferably 0.33 g: 150-200 μL.

In the present disclosure, the encapsulation preferably includes: mixing the chitooligosaccharide-cellulose emulsion and the jasmine essential oil and stirring same at a rotational speed of preferably 500 r/min for preferably 6 h, wherein the stirring is preferably magnetic stirring.

In the present disclosure, after mixing the chitooligosaccharide-cellulose emulsion and the jasmine essential oil, the preparation method preferably further includes: pre-freezing the resulting mixed solution and drying same, wherein the pre-freezing is preferably carried out in a refrigerator at −80° C. for 6 h, and the drying is preferably lyophilization, preferably carried out under vacuum at −60° C. for 48 h.

The present disclosure further provides use of the jasmine essential oil-chitooligosaccharide-cellulose composite described in the technical solution above in flavored instant tea.

In the present disclosure, the flavored instant tea preferably includes one or more of instant black tea, instant green tea, instant white tea, instant dark tea, and instant oolong tea. The mass ratio of the instant black tea to the jasmine essential oil-chitooligosaccharide-cellulose composite is preferably 1 g:0.002-0.004 g; the mass ratio of the instant green tea to the jasmine essential oil-chitooligosaccharide-cellulose composite is preferably 1 g:0.002-0.004 g; the mass ratio of the instant white tea to the jasmine essential oil-chitooligosaccharide-cellulose composite is preferably 1 g:0.002-0.006 g; the mass ratio of the instant dark tea to the jasmine essential oil-chitooligosaccharide-cellulose composite is preferably 1 g:0.002-0.006 g; and the mass ratio of the instant oolong tea to the jasmine essential oil-chitooligosaccharide-cellulose composite is preferably 1 g:0.006-0.01 g.

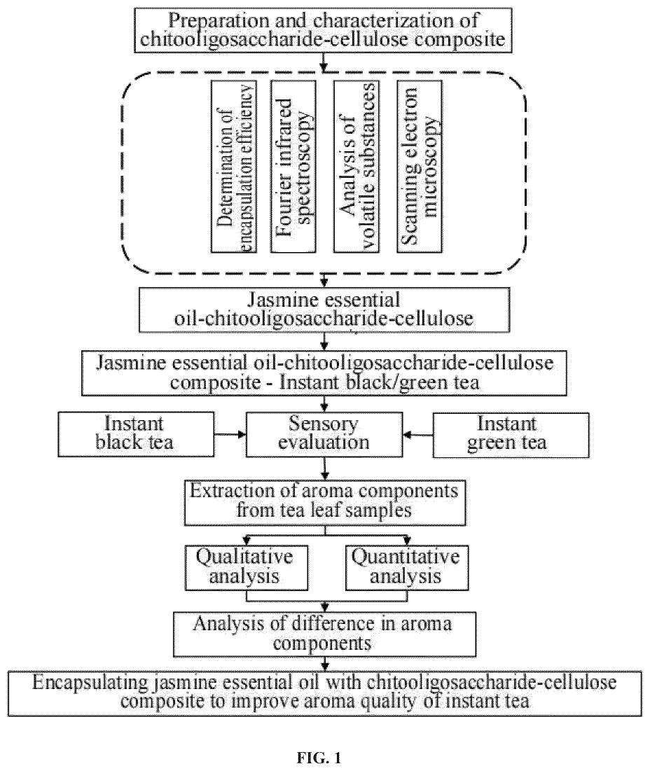

FIG. 1 shows the technology roadmap of the present disclosure. In the present disclosure, the jasmine essential oil is encapsulated in the chitooligosaccharide-cellulose composite, such that the prepared jasmine essential oil-chitooligosaccharide-cellulose composite has good aroma stability. The jasmine essential oil-chitooligosaccharide-cellulose composite is added, as an exogenous additive material, to five instant tea (instant black tea, instant green tea, instant dark tea, instant white tea, and instant oolong tea), the sensory changes in the aroma of the instant tea before and after adding the jasmine essential oil-chitooligosaccharide-cellulose composite are analyzed using sensory evaluation and overall odor assessment methods, and the changes in the content of the aroma substances in the instant black tea and instant green tea before and after adding the jasmine essential oil-chitooligosaccharide-cellulose composite are accurately analyzed by gas chromatography and olfactometry-mass spectrometry. It has been proven that the exogenous addition of the jasmine essential oil-chitooligosaccharide-cellulose composite can improve the aroma quality of flavored instant tea.

To further illustrate the present disclosure, the jasmine essential oil-chitooligosaccharide-cellulose composite provided by the present disclosure, and the preparation method therefor and use thereof are described in detail below in conjunction with the accompanying drawings and examples, which, however, cannot be construed as limiting the scope of protection of the present disclosure.

### EXAMPLE 1

### Preparation of Jasmine Essential Oil-Chitooligosaccharide-Cellulose Composite

### 1. Preparation of Chitooligosaccharide-Cellulose Composite

Chitooligosaccharides (a mixture with a molecular weight of less than 5000 Da) and cellulose (cellulose nanofibers) were selected and firstly pretreated to form homogeneous milky solutions, respectively. One gram of chitooligosaccharides were dissolved in 2 mL of 1% by volume acetic acid solution to obtain a homogeneous yellow milky solution, which was then left to stand at room temperature for later use; and 1 g of cellulose was dissolved in 2 mL of deionized water to obtain a homogeneous white milky solution, which was then left to stand at room temperature for later use. Appropriate amounts of the milky chitooligosaccharide solution and the milky cellulose solution were weighed and placed in beakers, such that the mass ratios of chitooligosaccharide to cellulose were 1:2, 1:1, 2:1, 3:1, and 4:1, respectively. The beakers were placed on a magnetic stirrer, and the mixed solutions were stirred at 500 r/min for 6 h until uniform, frozen in a refrigerator at −80° C. for 6 h, lyophilized (vacuum, −60° C., 48 h) and characterized.

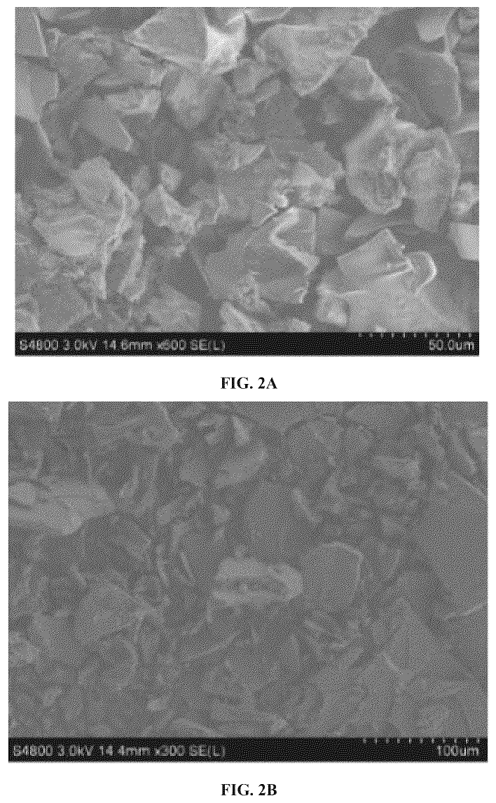

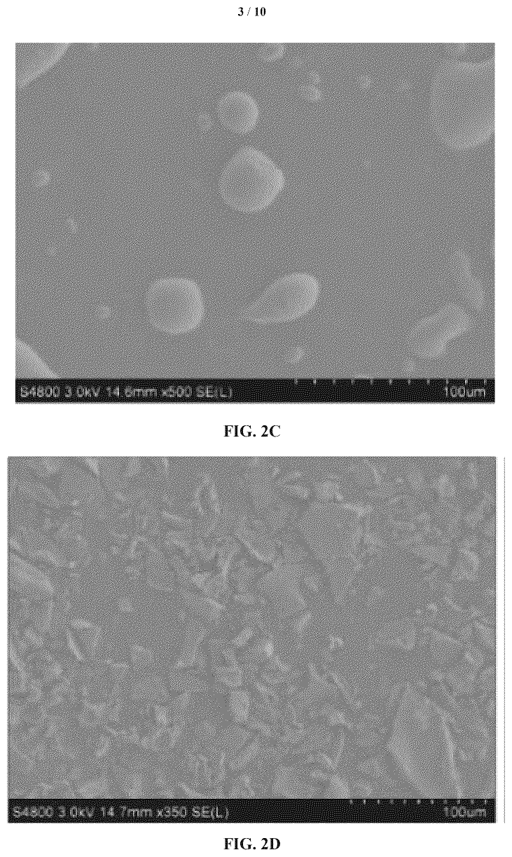

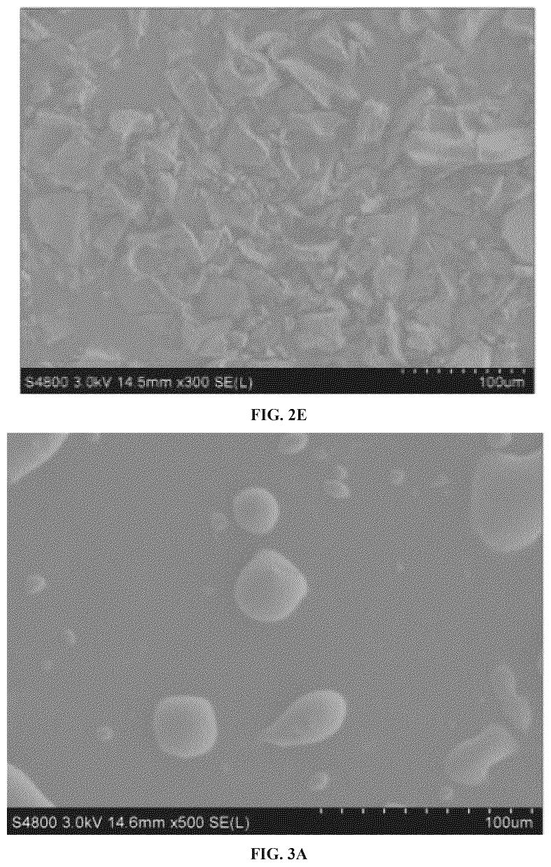

FIGS. 2A-2E show the scanning electron microscopy results of chitooligosaccharide-cellulose composites in different mass ratios (1:2, 1:1, 2:1, 3:1, and 4:1), where a represents the chitooligosaccharide-cellulose at a ratio of 1:2, b represents the chitooligosaccharide-cellulose at a ratio of 1:1, c represents the chitooligosaccharide-cellulose at a ratio of 2:1, d represents the chitooligosaccharide-cellulose at a ratio of 3:1, and e represents the chitooligosaccharide-cellulose at a ratio of 4:1. In FIGS. 2A-2E, the scale of FIG. 2A is 50 μm, and the scale of FIGS. 2B-2E is 100 μm. As can be seen from the scanning electron microscopy results, when the chitooligosaccharide-cellulose ratios were 1:2, 1:1, 3:1, and 4:1, the composites appeared as irregular spherical particles with adhesion to some extent. However, when the chitooligosaccharide-cellulose ratio was 2:1, the composite had a smooth appearance without depressions, and the particles thereof had substantially uniform sizes and were evenly distributed. Therefore, the optimum mass ratio of chitooligosaccharide to cellulose in the chitooligosaccharide-cellulose composite was 2:1.

### 2. Preparation of Jasmine Essential Oil-Chitooligosaccharide-Cellulose Composite

Varying amounts of jasmine essential oil were encapsulated with the chitooligosaccharide-cellulose composite prepared at the optimum ratio of 2:1. Specifically, jasmine essential oil was added to 1 g of the chitooligosaccharide-cellulose composite emulsion in 4 varying amounts (100μL, 150 μL, 200 μL, and 250 μL), respectively; and the resulting mixed solutions were stirred on a magnetic stirrer at 500 r/min for 6 h until uniform, frozen in a refrigerator at −80°° C. for 6 h, and lyophilized, followed by analysis of the encapsulation effect of the composite for the jasmine essential oil.

The results of the encapsulation efficiency for jasmine essential oil are shown in Table 1. When 150-200 μL of jasmine essential oil was added to 1 g of the chitooligosaccharide-cellulose composite emulsion, the encapsulation efficiency was significantly increased to 50%. When 150 μL or 200 μL of jasmine essential oil was added to 1 g of the chitooligosaccharide-cellulose composite emulsion, the resulting composites exhibited similar encapsulation efficiencies, and the aroma evaluation results thereof are both marked with pronounced floral aroma. In combination with the olfactory sensory evaluation results, it was determined that 200 μL of jasmine essential oil be added to 1 g of the chitooligosaccharide-cellulose composite emulsion subsequently.

TABLE 1
Experimental results of encapsulation efficiency

| Essential oil | Composite | Encapsulation | | |
|---|---|---|---|---|
| added (μL) | emulsion (g) | efficiency (%) | Sensory attributes | Sensory evaluation |
| 100 | 1.00 | 35.53 ± 0.70 | Pale yellow powder | Light floral aroma |
| 150 | 1.00 | 50.56 ± 0.44 | Yellow powder | Pronounced floral |
| | | | | aroma |
| 200 | 1.00 | 50.09 ± 0.67 | Yellowish-brown powder | Pronounced floral |
| | | | | aroma |
| 250 | 1.00 | — | Essential oil remained, not | — |
| | | | completely lyophilized | |

### Test Example 1

### 1. Characterization of Microstructure

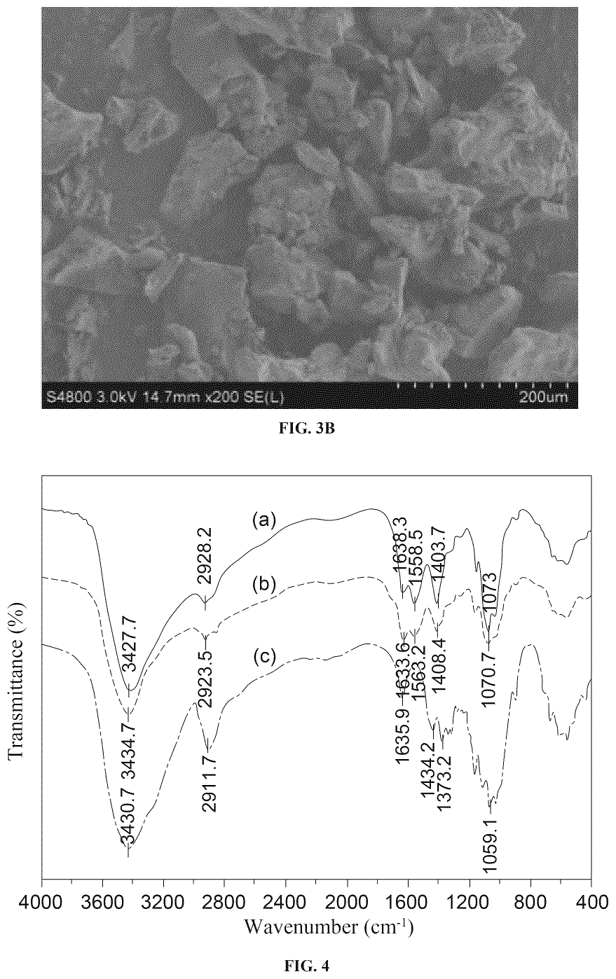

The microstructure of the chitooligosaccharide-cellulose composite (FIG. 3A) and the jasmine essential oil-chitooligosaccharide-cellulose composite (FIG. 3B) was analyzed. As shown in FIGS. 3A-3B, the chitooligosaccharide-cellulose composite has a smooth appearance without depressions, and the particles thereof have substantially uniform sizes and are evenly distributed. The scanning electron microscopy results show that the material appeared as uniformly distributed irregular particles after the jasmine essential oil was encapsulated, indicating that jasmine essential oil was successfully encapsulated by the chitooligosaccharide-cellulose composite.

### 2. Infrared Spectroscopy Characterization

The chitooligosaccharide, cellulose, and the chitooligosaccharide-cellulose composite were subjected to infrared analysis using a Fourier transform infrared spectrometer. The results are shown in FIG. 4, where (a) represents chitooligosaccharide-cellulose composite; (b) represents chitooligosaccharide; and (c) represents cellulose. As can be seen from (b) of FIG. 4, the O—H and —NH₂ of the chitooligosaccharide have a vibrational absorption peak at 3434.7 cm⁻¹, the C—H of the chitooligosaccharide has a vibrational absorption peak at 2923.5 cm⁻¹, the amido bonds of the chitooligosaccharide have vibrational absorption peaks at 1633.6 cm⁻¹, 1563.2 cm⁻¹, and 1408.4 cm⁻¹, and the C—O of the chitooligosaccharide has a vibrational absorption peak at 1070.7 cm⁻¹. As can be seen from (c) of FIG. 4, the CH₂—OH and O—H of the cellulose have a vibrational absorption peak at 3430.7 cm⁻¹, the C—H of the cellulose has a stretching vibration resulting in an absorption peak at 2911.7 cm⁻¹, the C—H of the cellulose has a bending vibration resulting in an absorption peak at 1373.2 cm⁻¹, and the β-1,4-glycosidic bond of the cellulose has a vibrational absorption peak at 1059.1 cm⁻¹. As can be seen from (a) of FIG. 4, the O—H and —NH₂ of the chitooligosaccharide and the CH₂—OH and O—H of the cellulose have an overlapped vibrational absorption peak at 3427.7 cm⁻¹, which indicates an enhanced vibrational intensity compared to the chitooligosaccharide; the C—H of the chitooligosaccharide and the C—H of the cellulose have an overlapped vibrational absorption peak at 2928.2 cm⁻¹, which indicates an enhanced vibrational intensity compared to the chitooligosaccharide; the amido bonds of the chitooligosaccharide and the C—H of the cellulose have bending vibrations resulting in overlapped absorption peaks at 1638.3 cm⁻¹, 1558.5 cm⁻¹, and 1403.7 cm⁻¹, which indicates an enhanced vibrational intensity compared to the chitooligosaccharide; and the C—O of the chitooligosaccharide and the β-1,4-glycosidic bond of the cellulose have an overlapped vibrational absorption peak at 1073 cm⁻¹, which indicates an enhanced vibrational intensity compared to the chitooligosaccharide. From the infrared results, it can be concluded that the chitooligosaccharide and the cellulose were successfully compounded.

### Test Example 2 Assessment of Aroma Stability of Jasmine Essential Oil-Chitooligosaccharide-Cellulose Composite

### 1. Qualitative and Quantitative Analysis of Aroma Substances of Jasmine Essential Oil

The qualitative and relative quantitative analysis of the volatile components of jasmine essential oil was carried out using solid phase microextraction (SPME) and internal standard methods combined with GC-MS/O, with ethyl caprate as the internal standard. The volatile components of jasmine essential oil and the contents thereof are shown in Table 2 below. A total of 57 aroma substances were detected. The results of this test showed that in the jasmine essential oil, the aroma components with a relative content (a ratio obtained by dividing the content of the substance by the content of all aroma components) of greater than 5% included linalyl acetate (15.30%), linalool (13.94%), benzyl alcohol (13.54%), benzyl acetate (9.81%), methyl benzoate (7.48%), methyl anthranilate (5.59%), and limonene (5.37%), and the components with a relative content of 1-5% included 2-phenylethanol (3.48%), 2-phenylethyl acetate (3.35%), methyl salicylate (3.26%), (Z)-3-hexenol (2.55%), eucalyptol (1.52%), benzyl benzoate (1.43%), (Z)-3-hexenyl acetate (1.38%), and (Z)-3-hexenyl benzoate (1.32%).

TABLE 2
Content of volatile aroma components of jasmine essential oil

| | | | Concentration | Relative |
|---|---|---|---|---|
| No. | Aroma substance | Scent attribute | (μg/μL) | content (%) |
| 1 | Ethyl acetate | Fruity | 0.35 ± 0.02 | 0.11 |
| 2 | α-Pinene | Pine needle | 0.12 ± 0.01 | 0.04 |
| 3 | β-Pinene | Pine needle, woody | 1.04 ± 0.07 | 0.32 |
| 4 | Sabinene | Woody, citrus | 0.18 ± 0.02 | 0.06 |
| 5 | Myrcene | Pleasant | 1.12 ± 0.09 | 0.35 |
| 6 | Limonene | Citrus | 17.3 ± 1.44 | 5.37 |
| 7 | Eucalyptol | Eucalyptus leaves | 4.89 ± 0.26 | 1.52 |
| 8 | Ocimene | Grass, floral | 0.34 ± 0.03 | 0.11 |
| 9 | γ-Terpinene | Gasoline | 0.09 ± 0.01 | 0.03 |
| 10 | (Z)-β-ocimene | Grass, floral | 1.24 ± 0.12 | 0.38 |
| 11 | p-Cymene | Citrus, gasoline | 0.49 ± 0.03 | 0.15 |
| 12 | Terpinolene | Citrus | 0.19 ± 0.02 | 0.06 |
| 13 | (Z)-3-hexenyl acetate | Grass, banana | 4.44 ± 0.17 | 1.38 |
| 14 | (E)-2-hexenyl acetate | Grass, banana | 0.17 ± 0.02 | 0.05 |
| 15 | 6-Methyl-5-hepten-2-one | Fruity | 0.17 ± 0.02 | 0.05 |
| 16 | 1-Hexanol | Grass, almond | 0.05 ± 0.00 | 0.02 |
| 17 | (Z)-3-hexenol | Fruity | 8.22 ± 0.23 | 2.55 |
| 18 | (E)-2-hexen-1-ol | Pleasant | 0.92 ± 0.10 | 0.29 |
| 19 | (Z)-linalool oxide | Floral, woody | 0.79 ± 0.07 | 0.25 |
| 20 | (E)-linalool oxide | Woody | 2.09 ± 0.18 | 0.65 |
| 21 | Camphor | Camphorated | 0.09 ± 0.01 | 0.03 |
| 22 | 3,7-Dimethyl-6-octen-3-ol | Woody, citrus | 0.95 ± 0.08 | 0.29 |
| 23 | Benzaldehyde | Almond | 1.04 ± 0.09 | 0.32 |
| 24 | Linalool | Citrus, floral | 44.9 ± 4.56 | 13.94 |
| 25 | Linalyl acetate | Citrus, soap | 49.3 ± 4.63 | 15.30 |
| 26 | Bornyl acetate | Pine needle | 0.14 ± 0.01 | 0.04 |
| 27 | β-Caryophyllene | Lilac | 0.25 ± 0.02 | 0.08 |
| 28 | Rose furan epoxide | Rose | 0.22 ± 0.01 | 0.07 |
| 29 | Methyl benzoate | Fruity, sweet | 24.1 ± 2.40 | 7.48 |
| 30 | Terpinyl acetate | Herbal | 2.28 ± 0.21 | 0.71 |
| 31 | α-Terpineol | Woody, floral | 1.23 ± 0.11 | 0.38 |
| 32 | Benzyl acetate | Sweet, fruity | 31.6 ± 3.03 | 9.81 |
| 33 | β-Cadinene | Woody | 1.85 ± 0.17 | 0.57 |
| 34 | α-Farnesene | Sweet, floral | 3.08 ± 0.28 | 0.96 |
| 35 | Geranyl acetate | Floral | 1.07 ± 0.08 | 0.33 |
| 36 | Linalool oxide (pyranoid) | Floral | 0.25 ± 0.01 | 0.08 |
| 37 | Methyl salicylate | Minty, refreshing | 10.5 ± 0.90 | 3.26 |
| 38 | Benzyl propanoate | Floral, fruity | 0.02 ± 0.00 | 0.01 |
| 39 | Nerol | Citrus | 0.47 ± 0.04 | 0.15 |
| 40 | 2-Phenylethyl acetate | Floral, honey | 10.8 ± 0.88 | 3.35 |
| 41 | Dihydrojasmone | Floral | 0.35 ± 0.02 | 0.11 |
| 42 | Geraniol | Rose, citrus | 1.04 ± 0.11 | 0.32 |
| 43 | Benzyl alcohol | Almond | 43.6 ± 4.00 | 13.54 |
| 44 | 2-Phenylethanol | Rose, honey | 11.2 ± 1.18 | 3.48 |
| 45 | Jasmone | Floral | 0.21 ± 0.01 | 0.07 |
| 46 | Nerolidol | Citrus, floral | 0.97 ± 0.06 | 0.30 |
| 47 | (E)-nerolidol | Citrus, floral | 1.68 ± 0.15 | 0.52 |
| 48 | Dimethyl anthranilate | Floral, sweet | 0.24 ± 0.02 | 0.07 |
| 49 | (Z)-3-hexenyl benzoate | Orchid | 4.24 ± 0.28 | 1.32 |
| 50 | Eugenol | Lilac | 1.40 ± 0.14 | 0.43 |
| 51 | Methyl anthranilate | Sweet | 18.0 ± 1.85 | 5.59 |
| 52 | (E)-methyl | Fruity, sweet | 2.30 ± 0.16 | 0.71 |
| | dihydrojasmonate | | | |
| 53 | (Z)-methyl | Fruity, sweet | 0.24 ± 0.02 | 0.07 |
| | dihydrojasmonate | | | |
| 54 | α-Hexyl cinnamaldehyde | Floral | 2.32 ± 0.15 | 0.72 |
| 55 | Benzoic acid | Formaldehyde smell | 0.04 ± 0.00 | 0.01 |
| 56 | Indole | Camphorated | 1.34 ± 0.14 | 0.42 |
| 57 | Benzyl benzoate | Floral | 4.61 ± 0.47 | 1.43 |

### 2. Qualitative and Quantitative Analysis of Aroma Substances in Jasmine Essential Oil-Chitooligosaccharide-Cellulose Composite

The qualitative and relative quantitative analysis of the volatile components of the jasmine essential oil-chitooligosaccharide-cellulose composite was carried out using SPME and internal standard methods combined with GC-MS/O. The volatile components found and the contents thereof are shown in Table 3 below. A total of 51 aroma substances were detected. Compared with jasmine essential oil, there were 2 additional aroma compounds, namely, octanal and acetic acid, in the jasmine essential oil-chitooligosaccharide-cellulose composite; and 8 aroma compounds were lost, namely, α-pinene, β-pinene, sabinene, ocimene, γ-terpinene, p-cymene, rose furan epoxide, and linalool oxide (pyranoid). Octanal and acetic acid are derived from the chitooligosaccharide-cellulose composite. In addition, the reason for the reduction of aroma compounds compared to jasmine essential oil may lie in certain losses during the encapsulation process and the low adsorption of the chitooligosaccharide-cellulose composite for the 8 aroma compounds.

TABLE 3
Content of volatile aroma components in jasmine essential
oil-chitooligosaccharide-cellulose composite

| | | | Concentration of | |
|---|---|---|---|---|
| | | | aroma substance in | Relative |
| No. | Aroma substance | Scent attribute | composite (μg/g) | content (%) |
| 1 | Ethyl acetate | Fruity | 3.16 ± 0.05 | 0.02 |
| 2 | Myrcene | Pleasant | 4.98 ± 0.25 | 0.04 |
| 3 | Limonene | Citrus | 132 ± 2.28 | 0.98 |
| 4 | Eucalyptol | Eucalyptus leaves | 16.9 ± 0.59 | 0.13 |
| 5 | (Z)-β-ocimene | Grass, floral | 5.06 ± 0.27 | 0.04 |
| 6 | Terpinolene | Citrus | 1.66 ± 0.10 | 0.01 |
| 7 | Octanal | Grass, citrus | 2.71 ± 0.12 | 0.02 |
| 8 | (Z)-3-hexenyl acetate | Grass, banana | 18.0 ± 0.76 | 0.13 |
| 9 | (E)-2-hexenyl acetate | Grass, banana | 1.11 ± 0.15 | 0.01 |
| 10 | 6-Methyl-5-hepten-2-one | Fruity | 4.89 ± 0.33 | 0.04 |
| 11 | 1-Hexanol | Grass, almond | 2.32 ± 0.30 | 0.02 |
| 12 | (Z)-3-hexenol | Fruity | 33.0 ± 2.05 | 0.25 |
| 13 | (E)-2-hexen-1-ol | Pleasant | 3.37 ± 0.19 | 0.03 |
| 14 | (Z)-linalool oxide | Floral, woody | 7.58 ± 0.63 | 0.06 |
| 15 | Acetic acid | Vinegar | 90.5 ± 6.28 | 0.68 |
| 16 | (E)-linalool oxide | Woody | 22.3 ± 0.75 | 0.17 |
| 17 | Camphor | Camphorated | 2.23 ± 0.26 | 0.02 |
| 18 | 3,7-Dimethyl-6-octen-3-ol | Woody, citrus | 2.26 ± 0.10 | 0.02 |
| 19 | Benzaldehyde | Almond | 217 ± 3.17 | 1.62 |
| 20 | Linalool | Citrus, floral | 409 ± 7.70 | 3.05 |
| 21 | Linalyl acetate | Citrus, soap | 355 ± 19.1 | 2.65 |
| 22 | Bornyl acetate | Pine needle | 2.96 ± 0.25 | 0.02 |
| 23 | β-Caryophyllene | Lilac | 2.77 ± 0.06 | 0.02 |
| 24 | Methyl benzoate | Fruity, sweet | 411 ± 8.74 | 3.07 |
| 25 | Terpinyl acetate | Herbal | 26.3 ± 2.63 | 0.20 |
| 26 | α-Terpineol | Woody, floral | 27.3 ± 1.89 | 0.20 |
| 27 | Benzyl acetate | Sweet, fruity | 2022 ± 81.3 | 15.09 |
| 28 | β-Cadinene | Woody | 25.8 ± 2.68 | 0.19 |
| 29 | α-Farnesene | Sweet, floral | 135 ± 5.54 | 1.01 |
| 30 | Geranyl acetate | Floral | 25.4 ± 2.14 | 0.19 |
| 31 | Methyl salicylate | Minty, refreshing | 74.4 ± 6.07 | 0.56 |
| 32 | Benzyl propanoate | Floral, fruity | 0.68 ± 0.06 | 0.01 |
| 33 | Nerol | Citrus | 12.5 ± 1.06 | 0.09 |
| 34 | 2-Phenylethyl acetate | Floral, honey | 105 ± 1.20 | 0.78 |
| 35 | Dihydrojasmone | Floral | 16.8 ± 2.22 | 0.13 |
| 36 | Geraniol | Rose, citrus | 19.8 ± 2.07 | 0.15 |
| 37 | Benzyl alcohol | Almond | 786 ± 16.2 | 5.86 |
| 38 | 2-Phenylethanol | Rose, honey | 161 ± 3.50 | 1.20 |
| 39 | Jasmone | Floral | 160 ± 4.28 | 1.19 |
| 40 | Nerolidol | Citrus, floral | 736 ± 18.8 | 5.49 |
| 41 | (E)-nerolidol | Citrus, floral | 790 ± 17.7 | 5.89 |
| 42 | Dimethyl anthranilate | Floral, sweet | 32.9 ± 3.76 | 0.25 |
| 43 | (Z)-3-hexenyl benzoate | Orchid | 952 ± 31.4 | 7.10 |
| 44 | Eugenol | Lilac | 168 ± 12.2 | 1.25 |
| 45 | Methyl anthranilate | Sweet | 1542 ± 50.0 | 11.50 |
| 46 | (E)-methyl dihydrojasmonate | Fruity, sweet | 942 ± 12.9 | 7.03 |
| 47 | (Z)-methyl dihydrojasmonate | Fruity, sweet | 128 ± 14.5 | 0.95 |
| 48 | α-Hexyl cinnamaldehyde | Floral | 1216 ± 96.9 | 9.07 |
| 49 | Benzoic acid | Formaldehyde smell | 5.40 ± 0.68 | 0.04 |
| 50 | Indole | Camphorated | 115 ± 8.24 | 0.86 |
| 51 | Benzyl benzoate | Floral | 1427 ± 30.4 | 10.65 |

### 3. Assessment of Aroma Stability of Jasmine Essential Oil-Chitooligosaccharide-Cellulose Composite

The aroma stability of the jasmine essential oil-chitooligosaccharide-cellulose composite was analyzed by means of SPME combined with GC-MS. The volatile aroma compounds were detected by means of GC-MS on days 0, 1, 3, 5, 10, 15, 30, 45, and 60, respectively, and the assay was repeated 3 times per sample. The test results obtained are shown in Table 4 below, all calculated as 100% on day 0.

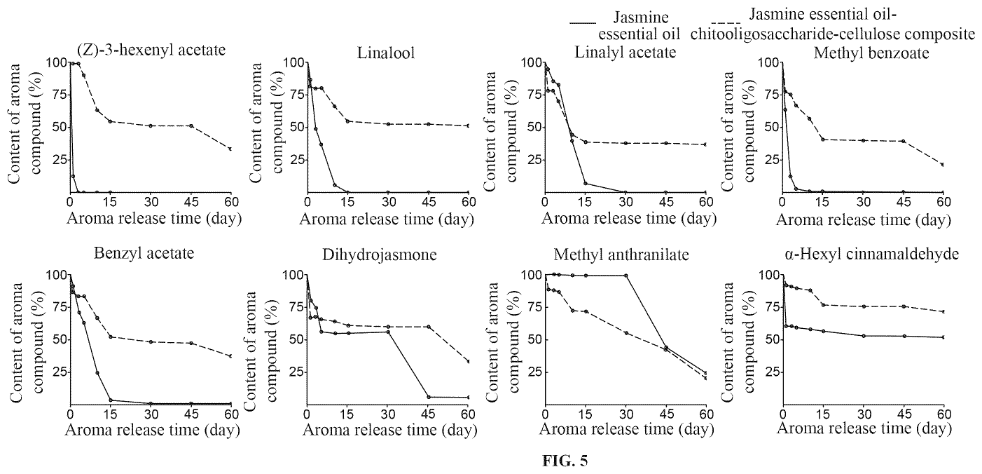

The jasmine essential oil and the jasmine essential oil-chitooligosaccharide-cellulose composite were placed in headspace bottles, uncapped, and left to stand at room temperature. As can be seen from Table 4, after 60 days, only 19 aroma compounds were detected in jasmine essential oil, while 46 major aroma compounds were still detected in the jasmine essential oil-chitooligosaccharide-cellulose composites, and the retention of the aroma compounds decreased slowly and evenly with standing time. Taking the 8 aroma compounds detected via GC-O in the jasmine essential oil and the jasmine essential oil-chitooligosaccharide-cellulose composite with a higher odor intensity than other compounds in the samples as examples, as shown in FIG. 5, the contents of the 8 aroma compounds, except for methyl anthranilate, in the jasmine essential oil dropped rapidly over 0-15 days, while those in the jasmine essential oil-chitooligosaccharide-cellulose composite decreased slowly and uniformly; and on day 60, the contents of the remaining aroma compounds in the jasmine essential oil-chitooligosaccharide-cellulose composite were all higher than those in the jasmine essential oil. The experimental results show that the chitooligosaccharide-cellulose composite had a good aroma stability effect on jasmine essential oil.

TABLE 4
Analysis results of aroma stability of jasmine essential oil and jasmine essential oil-chitooligosaccharide-cellulose composite

| | | | | | | | | | | Jasmine essential oil-chitooligosaccharide- | | | | | | | |
|---|---|---|---|---|---|---|---|---|---|---|---|---|---|---|---|---|---|
| | | Jasmine essential oil (%) | | | | | | | | cellulose composite (%) | | | | | | | |
| No. | Aroma substance | 1 d | 3 d | 5 d | 10 d | 15 d | 30 d | 45 d | 60 d | 1 d | 3 d | 5 d | 10 d | 15 d | 30 d | 45 d | 60 d |
| 1 | Ethyl acetate | 0 | 0 | 0 | 0 | 0 | 0 | 0 | 0 | 0 | 0 | 0 | 0 | 0 | 0 | 0 | 0 |
| 2 | Myrcene | 13 | 9 | 8 | 8 | 0 | 0 | 0 | 0 | 98 | 79 | 76 | 67 | 63 | 63 | 54 | 43 |
| 3 | Limonene | 0 | 0 | 0 | 0 | 0 | 0 | 0 | 0 | 85 | 85 | 84 | 76 | 72 | 72 | 71 | 60 |
| 4 | Eucalyptol | 1 | 0 | 0 | 0 | 0 | 0 | 0 | 0 | 95 | 94 | 91 | 80 | 68 | 67 | 65 | 57 |
| 5 | Ocimene, mixture | 6 | 4 | 4 | 2 | 1 | 0 | 0 | 0 | 100 | 100 | 100 | 92 | 82 | 82 | 80 | 77 |
| | of isomers | | | | | | | | | | | | | | | | |
| 6 | Terpinolene | 13 | 7 | 9 | 0 | 0 | 0 | 0 | 0 | 95 | 95 | 95 | 90 | 90 | 83 | 83 | 83 |
| 7 | Octanal | — | — | — | — | — | — | — | — | 99 | 57 | 47 | 34 | 22 | 22 | 22 | 0 |
| 8 | (Z)-3-hexenyl acetate | 12 | 0 | 0 | 0 | 0 | 0 | 0 | 0 | 99 | 99 | 90 | 63 | 54 | 51 | 51 | 33 |
| 9 | (E)-2-hexenyl acetate | 18 | 0 | 0 | 0 | 0 | 0 | 0 | 0 | 100 | 100 | 100 | 100 | 99 | 99 | 98 | 73 |
| 10 | 6-Methyl-5- | 7 | 0 | 0 | 0 | 0 | 0 | 0 | 0 | 99 | 99 | 99 | 99 | 99 | 95 | 94 | 94 |
| | hepten-2-one | | | | | | | | | | | | | | | | |
| 11 | 1-Hexanol | 0 | 0 | 0 | 0 | 0 | 0 | 0 | 0 | 100 | 95 | 95 | 92 | 92 | 90 | 89 | 89 |
| 12 | (Z)-3-hexenol | 3 | 0 | 0 | 0 | 0 | 0 | 0 | 0 | 93 | 93 | 93 | 87 | 56 | 32 | 31 | 16 |
| 13 | (E)-2-hexen-1-ol | 7 | 0 | 0 | 0 | 0 | 0 | 0 | 0 | 71 | 71 | 65 | 63 | 33 | 33 | 0 | 0 |
| 14 | (Z)-linalool oxide | 55 | 12 | 5 | 0 | 0 | 0 | 0 | 0 | 77 | 75 | 75 | 72 | 71 | 70 | 65 | 55 |
| 15 | Acetic acid | — | — | — | — | — | — | — | — | 100 | 64 | 63 | 45 | 35 | 28 | 23 | 20 |
| 16 | (E)-linalool oxide | 57 | 12 | 4 | 0 | 0 | 0 | 0 | 0 | 94 | 79 | 79 | 62 | 44 | 43 | 40 | 40 |
| 17 | D-camphor | 48 | 11 | 0 | 0 | 0 | 0 | 0 | 0 | 0 | 0 | 0 | 0 | 0 | 0 | 0 | 0 |
| 18 | 3,7-Dimethyl-6- | 99 | 80 | 74 | 31 | 4 | 0 | 0 | 0 | 93 | 93 | 93 | 52 | 48 | 47 | 46 | 45 |
| | octen-3-ol | | | | | | | | | | | | | | | | |
| 19 | Benzaldehyde | 77 | 50 | 41 | 27 | 16 | 12 | 9 | 8 | 90 | 90 | 89 | 75 | 52 | 52 | 51 | 49 |
| 20 | Linalool | 87 | 49 | 37 | 6 | 0 | 0 | 0 | 0 | 81 | 80 | 80 | 66 | 54 | 52 | 52 | 51 |
| 21 | Linalyl acetate | 94 | 85 | 82 | 40 | 7 | 0 | 0 | 0 | 78 | 78 | 70 | 44 | 38 | 38 | 37 | 37 |
| 22 | Bornylacetate | 64 | 14 | 14 | 14 | 0 | 0 | 0 | 0 | 70 | 62 | 60 | 33 | 22 | 22 | 22 | 21 |
| 23 | β-Caryophyllene | 90 | 74 | 59 | 34 | 9 | 0 | 0 | 0 | 53 | 53 | 51 | 30 | 30 | 29 | 26 | 23 |
| 24 | Methyl benzoate | 63 | 12 | 3 | 0 | 0 | 0 | 0 | 0 | 77 | 75 | 67 | 57 | 40 | 40 | 39 | 21 |
| 25 | Terpinyl acetate | 100 | 100 | 100 | 90 | 33 | 15 | 1 | 0 | 79 | 78 | 67 | 43 | 36 | 36 | 36 | 28 |
| 26 | α-Terpineol | 96 | 93 | 91 | 68 | 14 | 3 | 0 | 0 | 83 | 83 | 83 | 62 | 44 | 40 | 38 | 32 |
| 27 | Benzyl acetate | 90 | 70 | 63 | 24 | 3 | 0 | 0 | 0 | 86 | 83 | 83 | 66 | 51 | 48 | 47 | 37 |
| 28 | β-Cadinene | 100 | 100 | 100 | 100 | 72 | 61 | 9 | 7 | 87 | 80 | 79 | 49 | 37 | 38 | 17 | 17 |
| 29 | α-Farnesene | 87 | 86 | 86 | 85 | 48 | 48 | 14 | 4 | 75 | 74 | 74 | 39 | 29 | 27 | 16 | 11 |
| 30 | Geranyl acetate | 99 | 98 | 96 | 96 | 65 | 57 | 19 | 4 | 77 | 75 | 68 | 41 | 33 | 33 | 33 | 31 |
| 31 | Methyl salicylate | 89 | 51 | 39 | 7 | 1 | 0 | 0 | 0 | 83 | 78 | 62 | 36 | 33 | 33 | 32 | 17 |
| 32 | Benzyl propanoate | 98 | 89 | 89 | 64 | 14 | 0 | 0 | 0 | 0 | 0 | 0 | 0 | 0 | 0 | 0 | 0 |
| 33 | Nerol | 100 | 96 | 96 | 94 | 54 | 32 | 2 | 0 | 84 | 80 | 79 | 48 | 41 | 40 | 34 | 23 |
| 34 | 2-Phenylethyl acetate | 100 | 100 | 100 | 94 | 35 | 14 | 1 | 0 | 86 | 86 | 76 | 53 | 40 | 39 | 37 | 26 |
| 35 | Dihydrojasmone | 80 | 74 | 56 | 55 | 55 | 56 | 5 | 5 | 67 | 67 | 66 | 64 | 61 | 60 | 60 | 33 |
| 36 | Geraniol | 100 | 100 | 100 | 99 | 99 | 99 | 11 | 9 | 96 | 92 | 90 | 66 | 54 | 37 | 29 | 25 |
| 37 | Benzyl alcohol | 93 | 70 | 62 | 58 | 2 | 1 | 0 | 0 | 94 | 93 | 80 | 66 | 44 | 17 | 17 | 12 |
| 38 | 2-Phenylethanol | 100 | 100 | 99 | 62 | 16 | 4 | 0 | 0 | 97 | 97 | 92 | 64 | 43 | 23 | 20 | 17 |
| 39 | Jasmone | 100 | 100 | 100 | 97 | 97 | 96 | 94 | 40 | 89 | 88 | 88 | 60 | 47 | 44 | 33 | 21 |
| 40 | Nerolidol | 97 | 95 | 95 | 95 | 94 | 94 | 92 | 87 | 87 | 86 | 83 | 80 | 74 | 72 | 67 | 52 |
| 41 | (E)-nerolidol | 96 | 95 | 95 | 95 | 95 | 93 | 87 | 82 | 87 | 87 | 86 | 80 | 72 | 72 | 69 | 53 |
| 42 | Dimethyl anthranilate | 92 | 92 | 92 | 90 | 89 | 88 | 40 | 40 | 79 | 79 | 78 | 66 | 66 | 66 | 57 | 25 |
| 43 | (Z)-3-hexenyl benzoate | 88 | 87 | 86 | 85 | 83 | 78 | 78 | 76 | 84 | 83 | 83 | 71 | 71 | 70 | 64 | 32 |
| 44 | Eugenol | 100 | 99 | 95 | 94 | 94 | 92 | 63 | 17 | 89 | 88 | 87 | 45 | 45 | 38 | 27 | 13 |
| 45 | Methyl anthranilate | 100 | 100 | 100 | 99 | 99 | 99 | 44 | 24 | 88 | 88 | 86 | 72 | 71 | 55 | 42 | 20 |
| 46 | (E)-methyl | 100 | 100 | 100 | 98 | 98 | 97 | 95 | 93 | 83 | 82 | 80 | 80 | 76 | 76 | 74 | 70 |
| | dihydrojasmonate | | | | | | | | | | | | | | | | |
| 47 | (Z)-methyl | 99 | 99 | 99 | 99 | 97 | 94 | 94 | 91 | 84 | 83 | 83 | 83 | 74 | 74 | 68 | 58 |
| | dihydrojasmonate | | | | | | | | | | | | | | | | |
| 48 | α-Hexyl cinnamaldehyde | 60 | 60 | 59 | 57 | 56 | 52 | 52 | 51 | 91 | 90 | 89 | 88 | 76 | 75 | 75 | 71 |
| 49 | Benzoic acid | 100 | 95 | 95 | 94 | 90 | 88 | 88 | 87 | 100 | 100 | 89 | 68 | 48 | 47 | 47 | 46 |
| 50 | Indole | 99 | 99 | 96 | 96 | 96 | 96 | 30 | 28 | 95 | 95 | 82 | 63 | 64 | 63 | 43 | 26 |
| 51 | Benzyl benzoate | 86 | 86 | 80 | 79 | 79 | 78 | 78 | 76 | 90 | 89 | 86 | 85 | 85 | 85 | 83 | 81 |

### Application Example 1 Effect of Jasmine Essential Oil-Composite on Aroma of Instant Tea

### 1. Sensory Evaluation and Overall Odor Assessment of Tea Beverages

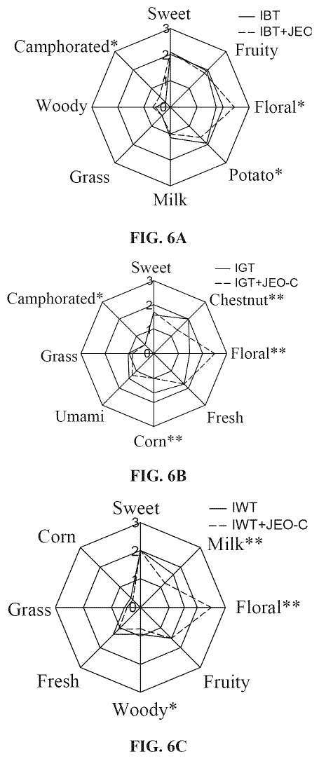

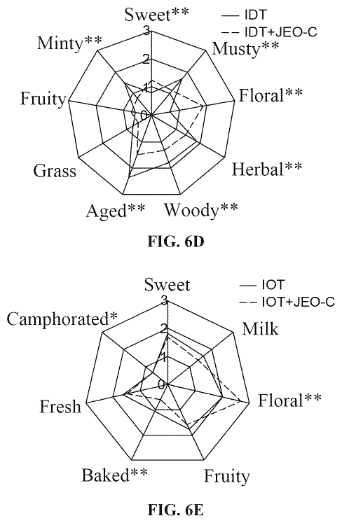

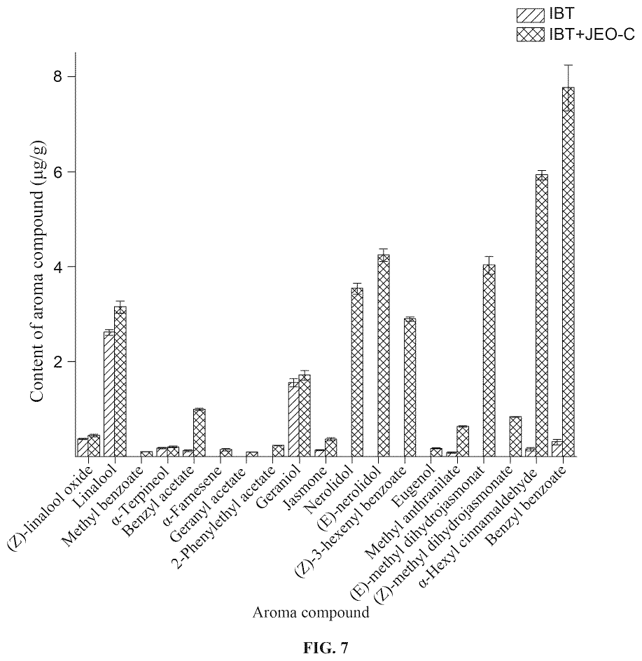

The aroma quality of 5 instant tea powders (instant black tea, instant green tea, instant white tea, instant dark tea, and instant oolong tea) and instant tea beverages infused with the jasmine essential oil-chitooligosaccharide-cellulose composite was evaluated by a review panel to verify the effect of the jasmine essential oil-chitooligosaccharide-cellulose composite on the aroma quality of the instant tea powders. The conventional sensory evaluation was conducted on the tea infusion from the instant teabefore and after the composite was added, focusing on both color and aroma. The optimal addition amounts of the composite for the 5 instant tea powders were finally determined, i.e., 0.002-0.004 g, 0.002-0.004 g, 0.002-0.006 g, 0.002-0.006 g, and 0.006-0.01 g added per gram of instant black tea, instant green tea, instant white tea, instant dark tea, and instant oolong tea, respectively. The aroma profiles of the tea infusion corresponding to the optimal addition amount are shown in FIGS. 6A-6E, where IBT is instant black tea, IGT is instant green tea, IWT is instant white tea, IDT is instant dark tea, IOT is instant oolong tea, and JEO-C is the jasmine essential oil-chitooligosaccharide-cellulose composite. The detailed results are as follows:

(1) The aroma profiles of instant black tea and the instant black tea infused with the jasmine essential oil-chitooligosaccharide-cellulose composite involved 8 main aroma types, namely, sweet, fruity, floral, potato, milk, grass, woody and camphorated aromas. As can be seen from FIG. 6A, the aroma profiles of the tea infusion from the instant black tea were approximately similar before and after the jasmine essential oil-chitooligosaccharide-cellulose composite was added, with significant differences (P<0.05) in floral, potato and camphorated aromas, indicating that the floral aroma of the instant black tea was significantly increased with the addition of the jasmine essential oil-chitooligosaccharide-cellulose composite.

(2) The aroma profiles of instant green tea and the instant green tea infused with the jasmine essential oil-chitooligosaccharide-cellulose composite involved 8 main aroma types, namely, sweet, chestnut, floral, fresh, corn, umami, grass, and camphorated aromas. As can be seen from FIG. 6B, the aroma profiles of the tea infusion from the instant green tea were approximately similar before and after the jasmine essential oil-chitooligosaccharide-cellulose composite was added, with significant differences (P<0.01) in floral, chestnut and corn aromas, indicating that the floral aroma of the instant green tea was significantly increased with the addition of the jasmine essential oil-chitooligosaccharide-cellulose composite.

(3) The aroma profiles of instant white tea and the instant white tea infused with the jasmine essential oil-chitooligosaccharide-cellulose composite involved 8 main aroma types, namely, sweet, milk, grass, floral, fruity, woody, fresh, and corn aromas. As can be seen from FIG. 6C, the aroma profiles of the tea infusion from the instant white tea were approximately similar before and after the jasmine essential oil-chitooligosaccharide-cellulose composite was added, and there were significant differences in floral, milk and woody aromas, specifically, with extremely significant differences (P<0.01) in floral and milk aromas and a significant difference (P<0.05) in woody aroma, indicating that the floral aroma of the instant white tea was significantly increased with the addition of the jasmine essential oil-chitooligosaccharide-cellulose composite.

(4) The aroma profiles of instant dark tea and the instant dark tea infused with the jasmine essential oil-chitooligosaccharide-cellulose composite involved 9 main aroma types, namely, sweet, musty, floral, herbal, woody, aged, grass, fruity, and minty aromas. As can be seen from FIG. 6D, there were significant differences between the aroma profiles of the tea infusion from the instant dark tea before and after the jasmine essential oil-chitooligosaccharide-cellulose composite was added, with significant differences (P<0.01) in sweet, musty, floral, herbal, woody, aged, and minty aromas, indicating that the floral and sweet aromas of the instant dark tea was significantly increased with the addition of the jasmine essential oil-chitooligosaccharide-cellulose composite.

(5) The aroma profiles of instant oolong tea and the instant oolong tea infused with the jasmine essential oil-chitooligosaccharide-cellulose composite involved 7 main aroma types, namely, sweet, milk, floral, fruity, baked, fresh, and camphorated aromas. As can be seen from FIG. 6E, the aroma profiles of the tea infusion of the instant oolong tea were approximately similar before and after the jasmine essential oil-chitooligosaccharide-cellulose composite was added, with significant differences (P<0.01) in floral and baked aromas, indicating that the floral aroma of the instant oolong tea was significantly increased with the addition of the jasmine essential oil-chitooligosaccharide-cellulose composite.

(6) The tea infusion from each instant tea infused with the jasmine essential oil-chitooligosaccharide-cellulose composite at an amount lower than the amounts described above had a weak floral aroma intensity, with no significant difference from the aroma intensity of the original tea infusion (P>0.05). Thus, adding the composite in an amount less than the optimal amount did not enhance the aroma. However, for the tea infusion from the instant tea infused with the jasmine essential oil-chitooligosaccharide-cellulose composite at an amount higher than the amounts described above, the aroma intensity of the jasmine essential oil had such a significant increase that the aroma of the tea itself was masked; in addition, the tea infusion was slightly turbid, with an oil film floating on the liquid surface of the tea infusion. Therefore, adding the composite at an amount higher than the optimum addition amount led to a decrease in the quality of color and aroma of the tea infusion.

### 2. Analysis of Difference in Contents of Aroma Components of Instant Black Tea

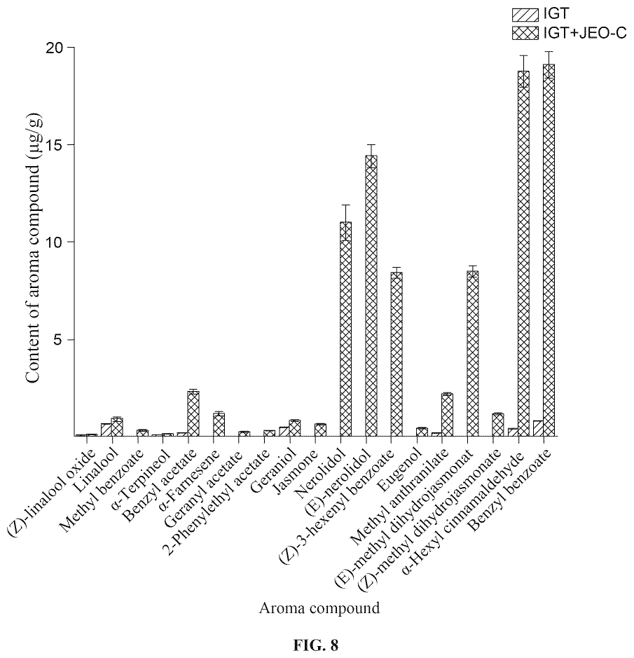

The qualitative and relative quantitative analysis of the volatile components of the instant black tea and the tea infusion from the instant black tea infused with the jasmine essential oil-chitooligosaccharide-cellulose composite was carried out using SPME and internal standard methods combined with GC-MS/O. The volatile components found and the contents thereof are shown in Table 5 below. A total of 60 aroma substances were detected, with 46 aroma substances detected in the tea infusion from the instant tea powder, and 49 aroma substances detected in the tea infusion from the instant black tea infused with the jasmine essential oil-chitooligosaccharide-cellulose composite. As shown in Table 5 and FIG. 7, compared to those of the tea infusion from the instant black tea, the contents of the compounds with floral and sweet attributes in the tea infusion from the instant tea powder infused with the jasmine essential oil-chitooligosaccharide-cellulose composite are significantly increased, including (Z)-linalool oxide, linalool, methyl benzoate, a-terpineol, benzyl acetate, a-farnesene, geranyl acetate, 2-phenylethyl acetate, jasmone, nerolidol, (E)-nerolidol, (Z)-3-hexenyl benzoate, eugenol, methyl anthranilate, (E)-methyl dihydrojasmonate, (Z)-methyl dihydrojasmonate, a-hexyl cinnamaldehydee and benzyl benzoate. Most were the characteristic aroma substances of jasmine essential oil. The experimental results are consistent with the sensory evaluation results.

TABLE 5
Content of volatile aroma components in instant black tea (IBT)
and tea infusion of instant black tea infused with jasmine essential
oil-chitooligosaccharide-cellulose composite (IBT + JEO-C)

| No. | Aroma substance | Scent attribute | IBT (μg/L) | IBT + JEO-C (μg/L) |
|---|---|---|---|---|
| 1 | Dimethyl sulfide | Poached corn | 0.01 ± 0.00 | 0.03 ± 0.00 |
| 2 | 3-Methylbutanal | Green apple | 0.02 ± 0.00 | 0.07 ± 0.00 |
| 3 | Limonene | Citrus | 0.03 ± 0.00 | 0.04 ± 0.01 |
| 4 | (Z)-β-ocimene | Grass, floral | 0.02 ± 0.00 | — |
| 5 | Terpinolene | Citrus | 0.02 ± 0.00 | 0.02 ± 0.00 |
| 6 | (Z)-3-hexenyl acetate | Grass, banana | — | 0.01 ± 0.00 |
| 7 | 2-Heptanol | Citrus | 0.02 ± 0.00 | 0.03 ± 0.00 |
| 8 | 6-Methyl-5-hepten-2-one | Fruity | 0.01 ± 0.00 | 0.01 ± 0.00 |
| 9 | 1-Hexanol | Grass, almond | 0.01 ± 0.00 | 0.02 ± 0.00 |
| 10 | (Z)-3-hexenol | Fruity | 0.05 ± 0.00 | 0.06 ± 0.00 |
| 11 | (E)-2-hexen-1-ol | Pleasant | — | 0.01 ± 0.00 |
| 12 | (E)-linalool oxide | Woody | 0.13 ± 0.00 | 0.16 ± 0.01 |
| 13 | 1-Octen-3-ol | Mushroom, floral | 0.02 ± 0.00 | 0.02 ± 0.00 |
| 14 | (Z)-linalool oxide | Floral, woody | 0.36 ± 0.01 | 0.43 ± 0.02 |
| 15 | Furfural | Baked, leather | 0.04 ± 0.00 | 0.05 ± 0.00 |
| 16 | Benzaldehyde | Almond | 0.24 ± 0.01 | 0.22 ± 0.02 |
| 17 | Linalool | Citrus, floral | 2.61 ± 0.06 | 3.14 ± 0.12 |
| 18 | 3,5-Octadien-2-one | Greasy, green pepper | 0.02 ± 0.00 | — |
| 19 | 5-Methyl furfural | Sweet, spicy | 0.03 ± 0.00 | 0.03 ± 0.00 |
| 20 | Methyl benzoate | Fruity, sweet | — | 0.09 ± 0.00 |
| 21 | Benzeneacetaldehyde | Floral, honey | 0.15 ± 0.01 | 0.11 ± 0.01 |
| 22 | Terpinyl acetate | Herbal | — | 0.05 ± 0.00 |
| 23 | α-Terpineol | Woody, floral | 0.16 ± 0.01 | 0.19 ± 0.01 |
| 24 | Benzyl acetate | Sweet, fruity | 0.11 ± 0.01 | 0.98 ± 0.02 |
| 25 | β-Cadinene | Woody | — | 0.05 ± 0.00 |
| 26 | α-Farnesene | Sweet, floral | — | 0.13 ± 0.02 |
| 27 | Geranyl acetate | Floral | — | 0.08 ± 0.00 |
| 28 | Methyl salicylate | Minty, refreshing | 1.66 ± 0.05 | 0.91 ± 0.03 |
| 29 | Nerol | Citrus | 0.09 ± 0.01 | 0.11 ± 0.00 |
| 30 | 2-Phenylethyl acetate | Floral, honey | — | 0.22 ± 0.00 |
| 31 | Damascenone | Floral | 0.13 ± 0.01 | — |
| 32 | α-Ionone | Violet | 0.02 ± 0.00 | — |
| 33 | Hexanoic acid | Sweat odor, musty | 0.08 ± 0.00 | — |
| 34 | Geraniol | Rose, citrus | 1.55 ± 0.08 | 1.70 ± 0.10 |
| 35 | Benzyl alcohol | Almond | 0.11 ± 0.00 | 0.16 ± 0.01 |
| 36 | 2-Phenylethanol | Rose, honey | 0.15 ± 0.00 | 0.14 ± 0.00 |
| 37 | Benzyl nitrile | Citrus | 0.02 ± 0.00 | — |
| 38 | β-Ionone | Violet | 0.15 ± 0.01 | — |
| 39 | Jasmone | Floral | 0.12 ± 0.01 | 0.36 ± 0.03 |
| 40 | Heptanoic acid | Sour | 0.07 ± 0.00 | 0.05 ± 0.01 |
| 41 | (E)-3-hexenoic acid | Sour, fruity | 0.06 ± 0.00 | 0.07 ± 0.00 |
| 42 | (E)-2-hexenoic acid | Fruity | 0.09 ± 0.01 | — |
| 43 | Nerolidol | Citrus, floral | — | 3.53 ± 0.11 |
| 44 | 2-Pyrrolecarbaldehyde | Floral | 0.03 ± 0.00 | 0.03 ± 0.00 |
| 45 | (E)-nerolidol | Citrus, floral | — | 4.23 ± 0.13 |
| 46 | 5-Methyl-2-phenylhex-2- | Baked, grass | 0.05 ± 0.00 | 0.05 ± 0.00 |
| | enal | | | |
| 47 | (Z)-3-hexenyl benzoate | Orchid | — | 2.89 ± 0.04 |
| 48 | Eugenol | Lilac | 0.01 ± 0.00 | 0.16 ± 0.01 |
| 49 | Nonanoic acid | Irritant odor | 0.11 ± 0.01 | 0.09 ± 0.01 |
| 50 | Methyl anthranilate | Sweet | 0.07 ± 0.01 | 0.62 ± 0.01 |
| 51 | (E)-methyl | Fruity, sweet | — | 4.02 ± 0.18 |
| | dihydrojasmonate | | | |
| 52 | 2,4-Di-tert-butylphenol | Phenolic | 0.08 ± 0.00 | 0.04 ± 0.00 |
| 53 | (Z)-methyl | Fruity, sweet | — | 0.82 ± 0.00 |
| | dihydrojasmonate | | | |
| 54 | Dihydroactinidiolide | Floral | 0.05 ± 0.00 | — |
| 55 | α-Hexyl cinnamaldehyde | Floral | 0.14 ± 0.03 | 5.92 ± 0.10 |
| 56 | 4-Vinylphenol | Phenolic | 0.02 ± 0.00 | — |
| 57 | Benzoic acid | Irritant | — | 0.07 ± 0.00 |
| 58 | Indole | Camphorated | 0.05 ± 0.01 | 0.09 ± 0.00 |
| 59 | Benzyl benzoate | Floral | 0.30 ± 0.05 | 7.76 ± 0.48 |
| 60 | Dibutyl phthalate | Floral | 0.15 ± 0.01 | — |

### 3. Analysis of Difference in Contents of Aroma Components of Instant Green Tea

The qualitative and relative quantitative analysis of the volatile components of the instant green tea and the tea infusion from the instant green tea infused with the jasmine essential oil-chitooligosaccharide-cellulose composite was carried out using SPME and internal standard methods combined with GC-MS/O. The volatile components found and the contents thereof are shown in Table 6 below. A total of 51 aroma substances were detected, with 32 aroma substances detected in the tea infusion from instant green tea, and 47 aroma substances detected in the tea infusion from the instant green tea infused with the jasmine essential oil-chitooligosaccharide-cellulose composite. As shown in Table 6 and FIG. 8, compared to the tea infusion from the instant green tea, the contents of the compounds with floral and sweet aromas in the tea infusion from the instant green tea infused with the jasmine essential oil-chitooligosaccharide-cellulose composite were significantly increased, including (Z)-linalool oxide, linalool, benzeneacetaldehyde, α-terpineol, benzyl acetate, geranyl acetate, methyl salicylate, 2-phenylethyl acetate, geraniol, α-farnesene, 2-phenylethanol, jasmone, nerolidol, (E)-nerolidol, (Z)-3-hexenyl benzoate, methyl anthranilate, (E)-methyl dihydrojasmonate, (Z)-methyl dihydrojasmonate, α-hexyl cinnamaldehydee, and benzyl benzoate, most of which are characteristic aroma compounds of jasmine essential oil. The experimental results are consistent with the sensory evaluation results.

TABLE 6
Content of volatile aroma components in instant green tea (IGT)
and tea infusion from instant green tea infused with jasmine essential
oil-chitooligosaccharide-cellulose composite (IGT + JEO-C)

| | | | Content of IGT | Content of IGT + |
|---|---|---|---|---|
| No. | Aroma substance | Scent attribute | (μg/g) | JEO-C (μg/g) |
| 1 | Dimethyl sulfide | Irritant odor | 0.02 ± 0.00 | 0.07 ± 0.00 |
| 2 | 3-Methylbutanal | Green apple | 0.01 ± 0.00 | 0.08 ± 0.00 |
| 3 | Myrcene | Pleasant | — | — |
| 4 | Limonene | Citrus | 0.01 ± 0.00 | 0.06 ± 0.01 |
| 5 | (Z)-β-ocimene | Grass, floral | 0.01 ± 0.00 | 0.04 ± 0.00 |
| 6 | Terpinolene | Citrus | 0.01 ± 0.00 | 0.06 ± 0.01 |
| 7 | Octanal | Grass, citrus | — | 0.02 ± 0.00 |
| 8 | (Z)-3-hexenyl acetate | Grass, banana | — | 0.03 ± 0.00 |
| 9 | 6-Methyl-5-hepten-2-one | Fruity | Mico amount | 0.02 ± 0.00 |
| 10 | (Z)-3-hexenol | Fruity | 0.01 ± 0.00 | 0.08 ± 0.01 |
| 11 | 1,3-Di-tert-butylbenzene | Irritant | 0.19 ± 0.00 | 0.39 ± 0.03 |
| 12 | (Z)-linalool oxide | Woody | 0.04 ± 0.00 | 0.04 ± 0.00 |
| 13 | (E)-linalool oxide | Floral, woody | 0.04 ± 0.00 | 0.07 ± 0.00 |
| 14 | 2-((methylthio)methyl)furan | Onion, spicy | 0.01 ± 0.00 | 0.10 ± 0.01 |
| 15 | Decanal | Pleasant | 0.01 ± 0.00 | 0.03 ± 0.00 |
| 16 | Benzaldehyde | Almond | 0.21 ± 0.00 | 0.39 ± 0.03 |
| 17 | Linalool | Citrus, floral | 0.63 ± 0.00 | 0.88 ± 0.11 |
| 18 | Linalyl acetate | Citrus, soap | 0.04 ± 0.00 | 0.87 ± 0.03 |
| 19 | β-Caryophyllene | Lilac | — | 0.02 ± 0.00 |
| 20 | 5-Methylfurfural | Sweet, spicy | — | 0.09 ± 0.01 |
| 21 | Methyl benzoate | Fruity, sweet | — | 0.28 ± 0.03 |
| 22 | Terpinyl acetate | Herbal | — | 0.14 ± 0.00 |
| 23 | α-Terpineol | Woody, floral | 0.04 ± 0.00 | 0.12 ± 0.00 |
| 24 | Benzyl acetate | Sweet, fruity | 0.17 ± 0.00 | 2.29 ± 0.10 |
| 25 | β-Cadinene | Woody | — | 0.17 ± 0.00 |
| 26 | α-Farnesene | Sweet, floral | — | 1.15 ± 0.10 |
| 27 | Geranyl acetate | Floral | — | 0.21 ± 0.03 |
| 28 | Methyl salicylate | Minty, refreshing | 0.23 ± 0.00 | 0.37 ± 0.02 |
| 29 | Nerol | Citrus | — | 0.11 ± 0.00 |
| 30 | 2-Phenylethyl acetate | Floral, honey | — | 0.27 ± 0.01 |
| 31 | Dihydrojasmone | Floral | — | 0.07 ± 0.00 |
| 32 | Geraniol | Rose, citrus | 0.44 ± 0.00 | 0.79 ± 0.04 |
| 33 | Benzyl alcohol | Almond | 0.07 ± 0.00 | 0.32 ± 0.02 |
| 34 | Butylated hydroxytoluene | Phenolic | 0.08 ± 0.00 | — |
| 35 | 2-Phenylethanol | Rose, honey | 0.04 ± 0.00 | 0.17 ± 0.00 |
| 36 | Phenylacetonitrile | Citrus | 0.02 ± 0.00 | — |
| 37 | Jasmone | Floral | 0.01 ± 0.00 | 0.61 ± 0.03 |
| 38 | Nerolidol | Citrus, floral | — | 10.99 ± 0.91 |
| 39 | (E)-nerolidol | Citrus, floral | — | 14.38 ± 0.59 |
| 40 | (Z)-3-hexenyl benzoate | Orchid | — | 8.40 ± 0.28 |
| 41 | Eugenol | Lilac | — | 0.39 ± 0.03 |
| 42 | Methyl anthranilate | Sweet | 0.15 ± 0.00 | 2.16 ± 0.06 |
| 43 | (E)-methyl dihydrojasmonate | Fruity, sweet | — | 8.46 ± 0.29 |
| 44 | 2,4-Di-tert-butylphenol | Phenolic | 0.75 ± 0.00 | 0.40 ± 0.03 |
| 45 | (Z)-methyl dihydrojasmonate | Fruity, sweet | — | 1.14 ± 0.04 |
| 46 | α-Hexyl cinnamaldehyde | Floral | 0.38 ± 0.00 | 18.7 ± 0.81 |
| 47 | 4-Vinylphenol | Phenolic | 0.01 ± 0.00 | 0.08 ± 0.01 |
| 48 | Benzoic acid | Formaldehyde | — | 0.12 ± 0.00 |
| | | smell | | |
| 49 | Indole | Camphorated | 0.13 ± 0.00 | 0.47 ± 0.01 |
| 50 | Benzyl benzoate | Floral | 0.77 ± 0.00 | 19.10 ± 0.67 |
| 51 | Dibutyl phthalate | Floral | 0.17 ± 0.00 | — |

In the present disclosure, an edible composite having good aroma stability is prepared by making a composite of chitooligosaccharides and cellulose and encapsulating jasmine essential oil with the composite. The aroma quality of the tea infusion from the instant black/green tea infused with the jasmine essential oil-chitooligosaccharide-cellulose composite is significantly improved.

Although the examples described above have provided a detailed description of the present disclosure, they are only a part of, rather than all of the embodiments of the present disclosure. All other embodiments that can be obtained according to the examples of the present disclosure without creative efforts shall fall within the scope of protection of the disclosure.

What is claimed is:

1. A jasmine essential oil-chitooligosaccharide-cellulose composite, comprising a shell material formed from a chitooligosaccharide-cellulose composite, and jasmine essential oil encapsulated in the shell material.

2. The jasmine essential oil-chitooligosaccharide-cellulose composite according to claim 1, wherein a ratio of the shell material to the jasmine essential oil is 0.33 g:150-200 μL.

3. A method for preparing the jasmine essential oil-chitooligosaccharide-cellulose composite according to claim 1, comprising the following steps:
mixing chitooligosaccharides and an acidic solution to obtain a first milky solution, and mixing cellulose and water to obtain a second milky solution;
mixing the first milky solution and the second milky solution for emulsification to obtain a chitooligosaccharide-cellulose emulsion; and
conducting encapsulation jasmine essential oil with the chitooligosaccharide-cellulose emulsion to obtain the jasmine essential oil-chitooligosaccharide-cellulose composite.

4. The method according to claim 3, wherein a ratio of the shell material to the jasmine essential oil is 0.33 g:150-200 μL.

5. The method according to claim 3, wherein the acidic solution is an acetic acid solution, acetic acid accounts for 1% by volume in the acetic acid solution, and the chitooligosaccharides has a concentration of 0.5 g/mL in the first milky solution.

6. The method according to claim 3, wherein the cellulose has a concentration of 0.5 g/mL in the second milky solution.

7. The method according to claim 5, wherein a mass ratio of chitooligosaccharides to cellulose in the chitooligosaccharide-cellulose emulsion is 1-4:1-2.

8. The method according to claim 7, wherein the cellulose has a concentration of 0.5 g/mL in the second milky solution.

9. The method according to claim 3, wherein the encapsulation comprises: mixing the chitooligosaccharide-cellulose emulsion and the jasmine essential oil and stirring same at a rotational speed of 500 r/min for 6 h.

10. A method for preparing flavored instant tea, comprising adding the jasmine essential oil-chitooligosaccharide-cellulose composite according to claim 1 to instant tea.

11. The method according to claim 10, wherein a ratio of the shell material to the jasmine essential oil is 0.33 g:150-200 μL.

12. The method according to claim 10, wherein the flavored instant tea comprises one or more of instant black tea, instant green tea, instant white tea, instant dark tea, and instant oolong tea.

13. The method according to claim 12, wherein a mass ratio of the instant black tea to the jasmine essential oil-chitooligosaccharide-cellulose composite is 1 g:0.002-0.004 g; a mass ratio of the instant green tea to the jasmine essential oil-chitooligosaccharide-cellulose composite is 1 g:0.002-0.004 g; the mass ratio of the instant white tea to the jasmine essential oil-chitooligosaccharide-cellulose composite is 1 g:0.002-0.006 g; a mass ratio of the instant dark tea to the jasmine essential oil-chitooligosaccharide-cellulose composite is 1 g:0.002-0.006 g; and a mass ratio of the instant oolong tea to the jasmine essential oil-chitooligosaccharide-cellulose composite is 1 g:0.006-0.01 g.
